(19) United States
(12) Patent Application Publication
(10) Pub. No.: US 2013/0201025 A1
(43) Pub. Date: Aug. 8, 2013

(54) Method of Monitoring a Gas Leakage Incident

(71) Applicants: Arunkumar Kamalakannan, Chennai (IN); Nukala Sateesh Kumar, Bangalore (IN); Irfan K., Bangalore (IN); Kanhayia Kumar, Bangalore (IN)

(72) Inventors: Arunkumar Kamalakannan, Chennai (IN); Nukala Sateesh Kumar, Bangalore (IN); Irfan K., Bangalore (IN); Kanhayia Kumar, Bangalore (IN)

(21) Appl. No.: 13/367,794

(22) Filed: Feb. 7, 2012

(51) Int. Cl. G08B 17/10; H04N 7/18

(52) U.S. Cl. 340/632; 348/159; 348/E07.085

(57) ABSTRACT

A system for monitoring a gas leakage incident in an industrial facility comprises a local area network, and a plurality of closed-circuit television cameras operatively connected to the local area network. The closed-circuit television cameras are positioned to provide video images of plural areas in a facility, with a central station operatively connected to the network for receiving video images from the television cameras. As plurality of gas detectors positioned in plural areas of the facility are operatively connected to the local area network, with each gas detector being operable to provide a signal which indicates occurrence of a gas leakage incident. Real-time monitoring of one or more gas-leakage incidents facilitates efficient evacuation of operating personnel, with the system preferably configured to automatically direct one or more of the closed-circuit television cameras to the area from which a gas leakage signal originates.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

The present disclosure relates to a method and system for monitoring a gas leakage incident in a facility, such as an industrial plant, and more particularly to a method by which plural live video images are integrated and recorded, to ensure proper response to the incident, and to facilitate subsequent review of the response.

### BACKGROUND

Industrial facilities such as refineries and the like require careful monitoring of potential gas leakage, and like incidents. Typically, fixed gas detectors are provided in the facility, while portable gas detectors are provided to operating personnel for quickly identifying any toxic gas leakage or the like. In the event of such an incident, it is necessary for personnel to quickly and efficiently evacuate an affected area, and move to areas of the facility not impacted by the gas leakage incident.

Heretofore, a gas leakage incident at a facility typically results in operating personnel receiving a localized alarm, whereupon the personnel exit the affected area to reach a safe evacuation zone. Emergency response team personnel typically receive an incident notification through a manual alarm, and as they arrive at the affected area, they will initiate and continue the evacuation procedure, in accordance with established guide lines.

While the above situation is not atypical, there are nevertheless certain short comings associated with this emergency procedure. Ordinarily, there is no central monitoring station to monitor the events, and the gas leakage alarm. Ordinarily, no central monitoring station is provided to track the location of those personnel carrying portable gas leakage detectors, and there is ordinarily no automated arrangement to inform emergency response team personnel of the gas leakage incident.

The lack of a central monitoring system makes it difficult or impossible to prioritize the evacuation procedure, with consideration of the incident area severity in the case of multiple gas leakage incidents. Ordinarily, there is no way to assess the evacuation status, and current condition of the operating personnel and incident area status in the event of the gas leakage emergency. Because there is ordinarily no central monitoring system, there is no way to provide alternative evacuation routes during the evacuation process, which can be important to minimize problems due to personnel congestion, potential alarm by the evacuees, and changes in the emergency condition, while increasing the probability that all evacuees reach a safe location. Typically, there is no live condition-based evacuation trough public addressing (PA) system, with the absence of a central monitoring system precluding audio/video-based post-incident analysis to ensure compliance with applicable standards, such as those provided by the Occupational Safety & Health Administration (OSHA).

The present disclosure is directed to a method of monitoring a gas leakage incident in a facility, and a system for practicing the method, which facilitates timely response, efficient evacuation of an affected area, and subsequent review of the incident and evacuation to ensure compliance with applicable regulations.

### SUMMARY

In accordance with the present disclosure, a method of monitoring a gas leakage incident in a facility comprising providing a system of closed-circuit television cameras, which are operated in conjunction with a plurality of gas detectors provided in plural areas of the facility. Upon an incident of gas leakage, the present method and system permit monitoring of evacuation of an affected area, thus assuring the safety of operating personnel in the facility. In the preferred form, the present method facilitates evaluation of the evacuation procedure by recording and archiving video images for subsequent analysis of the incident response.

In accordance with the disclosed method, an incident of gas leakage in a facility is monitored by providing a local area network (LAN). A plurality of closed-circuit television cameras are provided operatively connected to the local area network. The cameras are positioned to provide video images of plural areas of the facility being monitored.

In accordance with the present disclosure, a central station is provided which is operatively connected to the local area network for receiving video images from the closed-circuit television cameras. Real time assessment of the areas of the facility is thus provided by on-demand, live video feed from the cameras monitoring the various areas of the facility.

The present method further includes providing a plurality of gas detectors, including fixed and wireless detectors, in plural areas of the facility, including operatively connecting the gas detectors to the local area network. Each of the gas detectors is operable to provide a signal which indicates occurrence of a gas leakage incident.

By the provision of the gas detectors, the occurrence of a gas leakage incident in the facility can be identified by a signal provided by at least one of the gas detectors. In response, the present method contemplates monitoring at least one area in the facility in which the gas leakage incident occurs, by evaluating video images provided by one or more of the closed-circuit television cameras at the central station. Automatic redirection of one or more cameras is preferably effected to provide video images of the area from which the gas leakage signal has originated. This permits a Location Manager, in the form of a monitoring system at the central station, to efficiently track operating personnel in the facility, direct movement of the personnel as may be required to facilitate efficient evacuation, and to monitor the facility in real time, in the aftermath of the gas leakage incident.

In order to subsequently to view, analyze, and evaluate the response to the gas leakage incident, the present method contemplates recording and archiving of video images from the closed-circuit television cameras. This permits subsequent, post-incident analysis for promoting efficient evacuation procedures while ensuring compliance with applicable regulations.

Other features and advantages of the present disclosure will become readily apparent from the following detailed description, the accompanying drawings, and the appended claims.

### BRIEF DESCRIPTION OF THE DRAWINGS

FIG. 1 is a diagrammatic view of a system for monitoring a gas leakage incident in a facility for practicing the method of the present disclosure;

FIG. 2 is a flow diagram illustrating operation of the present system for configuring a central station (including a monitoring system, i.e., Location Manager) of the present system; and

FIG. 3 is a flow diagram illustrating operation of the present system for monitoring a gas leakage incident in a facility.

### DETAILED DESCRIPTION

While the present method and system are susceptible of embodiment in various forms, there is shown in the drawings and will hereinafter be described presently preferred embodiments, with the understanding that the present disclosure is to be considered as an exemplification of the present method and system, it is not intended to limit the disclosure to the specific embodiments illustrated and described herein.

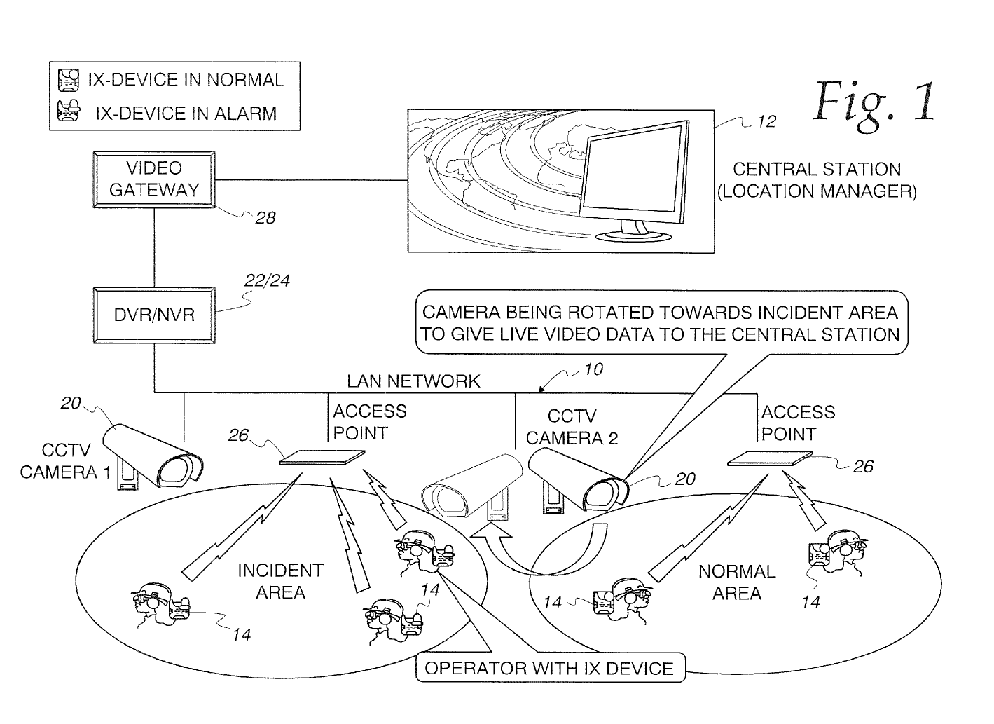

With reference now to FIG. 1, therein is diagrammatically illustrated a system for monitoring a gas leakage incident in an industrial facility such as a refinery, or the like. The present system, and method of its operation, facilitate efficient evacuation of operating personnel in the event of a gas leakage incident in one or more areas in the facility, and is further preferably configured to facilitate recording and archiving of video/audio images received from closed-circuit television cameras of the system. The system facilitates direction of the cameras of the system for real time evaluation of an area from which an alarm signal originates. Real time video imaging facilitates efficient evacuation, with recording and archiving of the video images facilitating subsequent review and analysis, thus enhancing operator safety and facilitating compliance with applicable regulations.

As shown in FIG. 1, the present system includes a local area network 10 which provides input of video images, and gas-detection alarms, to a central station 12, operated by a monitoring system designated Location Manager (LM). Gas detection is provided by a plurality of gas detectors, which may comprise wireless portable gas detectors 14, as well as fixed gas detectors. In the preferred practice of the present method, it is contemplated that operating personnel in the facility are provided with one or more gas detectors in the form of portable gas detectors 14, by which movement of the personnel can be monitored by monitoring of one or more portable gas detectors. Wireless infrastructure in the form of plural wireless access points 26 can gather location information from such wireless gas detectors for input into the local area network 10. GPS (global positioning system) based location tracking can be employed, as may be particularly suitable in an outdoor environment.

The present system further includes a plurality of closed-circuit television cameras 20 operatively connected to the local area network 10. The television cameras 20 are configured for intrinsically safe operation in a potentially hazardous environment, and are preferably equipped with remotely-operable pan, tilt, zoom, iris, and focus control features. The television cameras 20 are suitably mounted on walls, ceilings, and other structures within the facility, and are operatively connected with local area network 10 to provide live video/audio feed from plural areas within the facility.

In the preferred form, at least one of: (1) a digital video recorder 22, and (2) a network video recorder 24, are provided which are operatively connected to the local area network 10. This permits archiving of video images provided by the closed-circuit television cameras 20 to facilitate review of response to a gas leakage incident, including evacuation of operating personnel.

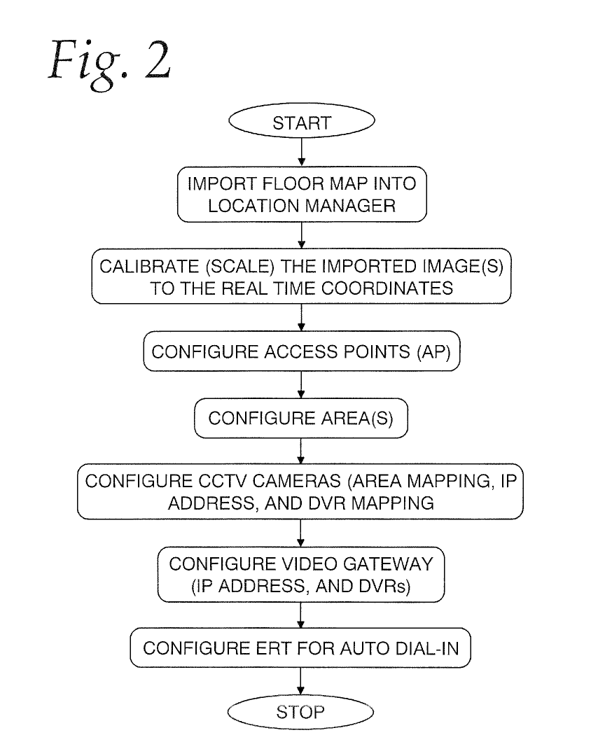

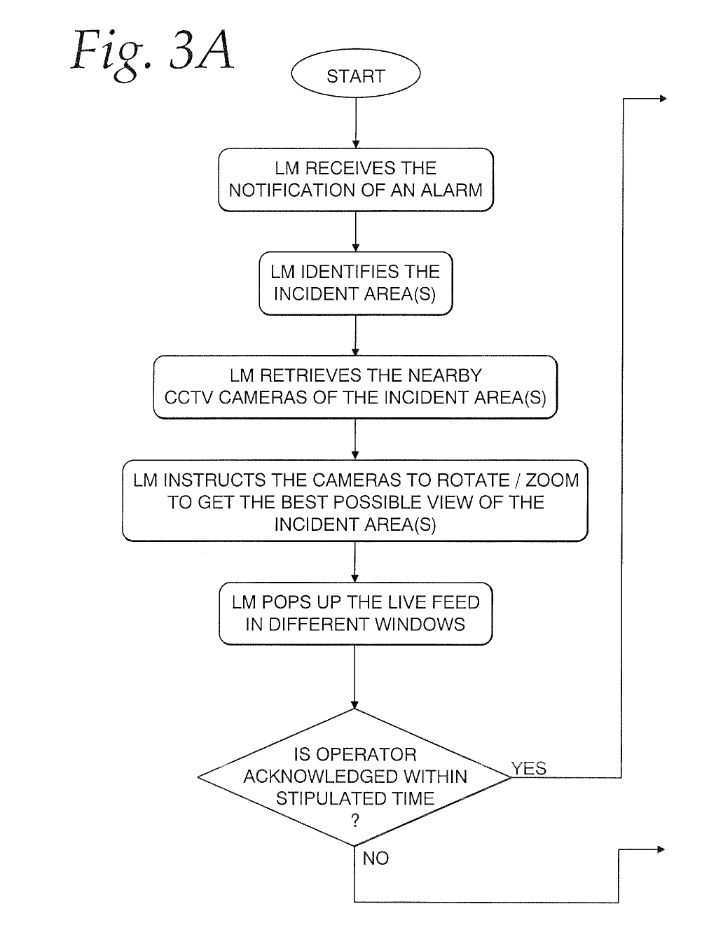

FIG. 2 illustrates a flow diagram by which the central station (monitored by the Location Manager) of the present system can be configured. As shown, a floor map of the facility can be imported to the Location Manager, and imported images calibrated to real time coordinates. Access points for portable gas detectors can be configured, as can be the areas from which monitoring is to be effected.

The closed circuit television cameras 20 can be configured, including area mapping, internet protocol address, and digital recorder mapping. The video gateway 28 of the system can also be configured, including configuring the internet protocol address, and digital video recorders. The system is also preferably configured for automatically notifying emergency response team personnel for automatic dial-in.

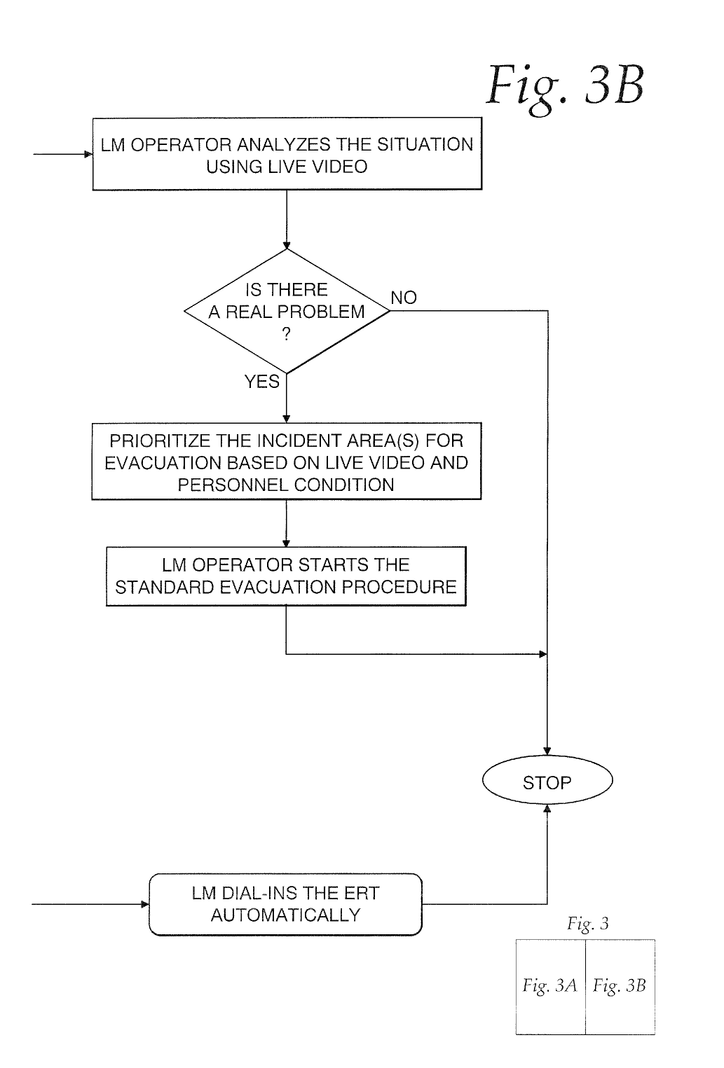

FIG. 3 is a flow diagram illustrating operation of the present system for monitoring a gas leakage incident in a facility. In the event of an incident, the Location Manager receives notification of the alarm by a signal provided to the local area network 10 by one or more of the gas detectors of the monitoring system.

The signal received from one or more of the gas detectors is provided to the local area network 10 through one of the access points 26 thereof, whereby the Location Manager can identify the one or more areas of the facility at which a gas leakage incident has occurred. This permits the Location Manager to automatically direct one or more of the closed-circuit television cameras 20 to retrieve video images from the cameras 20 in the one or more incident areas from which the signal originated, with the Location Manager being able to direct, aim, and focus the television cameras as may be required. Thus, the Location Manager automatically directs the television cameras to provide the best possible view of the one or more incident areas.

Video images from the closed-circuit television cameras 20 are provided, via local area network 10, to the central station with real time video feed provided to the Location Manager, typically by a plurality of viewing windows on the one or more monitors at the central station 12.

At this point in operation of the system, the Location Manager determines whether the alarm is acknowledged within a stipulated time period. If not, the system automatically dials in the emergency response team (ERT).

In the event that acknowledgement takes place, the Location Manager permits analysis of the situation using live video images provided by the closed-circuit television cameras 20. This permits evaluation of whether or not an actual gas leakage incident has occurred. If not, no further action is required. However, if such an incident has occurred, it is necessary to prioritize the incident areas for evacuation, based on live video and personnel condition. The Location Manager operator initiates the standard evacuation procedure.

As will be appreciated, the present system for monitoring a gas leakage incident in a facility provides distinct advantages over previously known monitoring procedures. The present system desirably permits prioritization of incident areas for facilitating efficient evacuation during multiple, concurrent gas leakage incidents. The present system facilitates automatic control of the closed-circuit television cameras by virtue of their operative connection to the local area network, in turn connected with the wireless access points 26 for receiving signals from the gas detectors of the system.

The present system is further operable to detect and eliminate so-called false man-down alarms, since the live video feeds provided by the system permit verification of personnel status. In the event of a disruption in the communication with operating personnel (such as by disruption in the signal from one of the portable gas detectors 14), by which the operator is considered “lost”, the present system can be operated to trace the “lost” operator based upon his previous location using surrounding camera configurations. The system can be operated to invoke the surrounding cameras to trace the operator to thereby determine his current location.

By integration of the various components of the present system, automated, real-time images are provided from incident area gas leakage incident areas within the facility. Real-time images of operating personnel within the facility are also provided. Enhanced and real time “situation awareness” is provided to the Location Manager operator. This, in turn, permits suitable instructions and directions to be provided to operating personnel, as well as to emergency response team personnel, based upon live audio/video images of the affected areas. Automatic notification of emergency response team personnel from the central station Location Manager during a gas leakage incident ensures a timely response. By virtue of the real-time images provided by the present system, alternate evacuation routes can be provided during the evacuation process itself, thereby desirably minimizing problems due to congestion, potential alarm by evacuees, and changes in the emergency condition while increasing the probability that evacuees will reach a safe location. Plant personnel and emergency response team personnel can be instructed using the facility's public address (PA) system, with instructions and directions based upon real-time video and audio information.

By including either a digital video recorder and/or network video recorder in the present system, video/audio images from the closed-circuit video cameras 20 can be recorded and archived for subsequent post-incident analysis, thus facilitating enhanced response in the event of an emergency, as well as facilitating compliance with applicable regulations.

Thus, the features and advantages of the present system and method will be readily appreciated. The present system permits prioritization of incident area(s) for facilitating efficient evacuation, particularly during multiple, concurrent gas leakage incidents. Live video/audio feed of incident area(s), in an emergency, are provided to promote safe and efficient evacuation of operating personnel.

Automatic control (direction) of the closed-circuit television cameras permits the cameras to be directed to the one or more incident areas, based upon incident area location. Automated viewing of real-time conditions in the incident areas, and of operating personnel, is thus provided.

Instructions to personnel, and emergency response team personnel, can be provided on the basis of a live video/audio feed of incident areas, thus ensuring efficient evacuation during emergency response. Emergency response is further facilitated by automatic notification of emergency response team personnel from the central station (Location Manager) of the system.

By the use of suitable video monitors, including suitable color monitors, a visual alert can be provided to the operator at the central station to draw attention to the one or more incident areas being monitored. Instructions based upon the real-time video/audio feed permits use of the public addressing system for providing instructions to personnel and the emergency response team. An evacuation status alert can be provided to the operator at the central station, based on operator presence in the incident area (under the camera coverage) through image processing.

Although certain embodiments discussed herein have been described in detail above, other modifications are possible. Other steps may be provided, or steps may be eliminated, from those described above, and other components may be added to or removed from, the described systems. Other embodiments may be within the scope of the following claims.

1. A method of monitoring a gas leakage incident in a facility, comprising the steps of:
providing a local area network;
providing a plurality of closed-circuit television cameras operatively connected to said local area network, and positioning said cameras to provide video images of plural areas of said facility;
providing a central station operatively connected to said local area network for receiving video images from said closed-circuit television cameras;
providing a plurality of gas detectors, in plural areas of said facility, including operatively connecting said gas detectors to said local area network, each of said gas detectors being operable to provide a signal which indicates the occurrence of a gas leakage incident;
identifying the occurrence of a gas leakage incident in said facility by a signal provided by at least one of said gas detectors; and
monitoring at least one area in said facility in which said incident occurs, by evaluating video images provided by one or more of said closed-circuit television cameras at said central station.

2. A method of monitoring a gas leakage incident in accordance with claim 1, including
recording of said video images for subsequent analysis of incident response.

3. A method of monitoring a gas leakage incident in accordance with claim 1, including
automatically notifying emergency response team personnel of the occurrence of the incident.

4. A method of monitoring a gas leakage incident in accordance with claim 1, including
providing personnel in said facility with one or more of said gas detectors in the form of portable gas detectors, and monitoring movement of said one or more portable gas detectors.

5. A method of monitoring a gas leakage incident in accordance with claim 1, including
automatically directing one or more of said closed-circuit television cameras to provide video images of an area of the facility from which said signal originates.

6. A system for monitoring a gas leakage incident in a facility, comprising:
a local area network;
a plurality of closed-circuit television cameras operatively connected to said local area network, said closed-circuit television cameras being positioned to provide video images of plural areas of said facility;
a central station operatively connected to said local area network for receiving video images from said closed-circuit television cameras; and
a plurality of gas detectors positioned in plural areas of said facility, said gas detectors being operatively connected to said local area network, each of said gas detectors being operable to provide a signal which indicates occurrence of a gas leakage incident to said local area network to facilitate direction of said closed-circuit television cameras for real-time evaluation of an area from which said signal originates.

7. A system for monitoring a gas leakage incident, including
at least one of: (1) a digital video recorder, and (2) a network video recorder, operatively connected to said local area network, to for archiving video images provided by said closed-circuit television cameras to facilitate review of response to a gas leakage incident.
